(19) United States
(12) Patent Application Publication
(10) Pub. No.: US 2025/0389622 A1
(43) Pub. Date: Dec. 25, 2025

(54) KINETIC ANALYSIS METHOD FOR MARINE VALVE CAMSHAFT SYSTEM IN CONSIDERATION OF FRICTION EFFECT

(71) Applicant: Harbin Engineering University, Harbin (CN)

(72) Inventors: Xiujiang SHI, Harbin (CN); Deliang HUA, Harbin (CN); Wanyou LI, Harbin (CN); Xiqun LU, Harbin (CN); Zhijun LV, Harbin (CN); Yibin GUO, Harbin (CN); Xuan MA, Harbin (CN); Donghua WANG, Harbin (CN); Bin ZHAO, Harbin (CN); Pengfei SUN, Harbin (CN)

(21) Appl. No.: 18/944,419

(22) Filed: Nov. 12, 2024

(30) Foreign Application Priority Data
Jun. 21, 2024 (CN) 2024108121864

(51) Int. Cl. G01M 15/05; F01L 1/047

(52) U.S. Cl. CPC G01M 15/05; F01L 1/047

(57) ABSTRACT

Disclosed is a kinetic analysis method for a marine valve camshaft system in consideration of a friction effect. The method includes the following steps: S1, computing load torque of a camshaft: computing the load torque of the camshaft during the operation on the basis of composition and an operation condition of a valve train; S2, computing torsional vibration of the valve camshaft system: analyzing, on the basis of an excitation condition of the load torque of the valve camshaft, a torsional vibration phenomenon of the camshaft system and influence of the friction effect on vibration characteristics in combination with physical properties including stiffness, damping and a moment of inertia of the camshaft system; and S3, conducting comprehensive result analysis and influence evaluation: comprehensively analyzing and evaluating a torsional vibration result, and paying attention to influence of the friction effect on the camshaft system.

### TECHNICAL FIELD

The present disclosure relates to the technical field of marine diesel engines, and particularly relates to a kinetic analysis method for a marine valve camshaft system in consideration of a friction effect.

### BACKGROUND

A valve camshaft system is a vital part of a marine diesel engine. It is responsible for controlling air intake and exhaust valves to be opened and closed, so as to ensure that an engine can operate efficiently and reliably under various working conditions. Performance of the valve camshaft system has direct influence on power output, fuel economy and emission performance of the entire engine. Therefore, it is particularly important to deeply analyze and optimize its kinetic behaviors, especially in consideration of influence of a friction effect on its kinetic performance.

In the prior art, for kinetic analysis of the valve camshaft system, basic mechanical effects, such as a spring force, an inertial force and a pneumatic force, are generally considered, but potential influence of the friction effect on system performance is often ignored. Friction may lead to energy loss and increase in fuel consumption, further cause additional heat load, aggravate component wear and even influence system stability and reliability. In addition, the friction effect is also closely related to a lubrication state. An improper lubrication condition may lead to serious problems such as adhesive wear and oil film fracture, which will further influence normal operation of the engine.

### SUMMARY

In view of the above objective, the present disclosure provides a kinetic analysis method for a marine valve camshaft system in consideration of a friction effect.

The kinetic analysis method for a marine valve camshaft system in consideration of a friction effect includes the following steps:
S1, computing load torque of a camshaft: computing the load torque borne by the camshaft during the operation on the basis of composition (including a cam, a tappet, a push rod, an air valve and other components) and an operation condition (such as different rotational speeds and loads) of a valve train;
S2, computing torsional vibration of the valve camshaft system: analyzing, on the basis of an excitation condition of the load torque of the valve camshaft, a torsional vibration phenomenon of the camshaft system and influence of the friction effect on vibration characteristics in combination with physical properties including stiffness, damping and a moment of inertia of the camshaft system; and
S3, conducting comprehensive result analysis and influence evaluation: comprehensively analyzing and evaluating a torsional vibration result, and paying attention to influence of the friction effect on the camshaft system.

Further, the computing load torque of a camshaft in S1 includes:
S11, computing the force of the valve train: computing a force F₁ between a cam and a tappet, where a computation formula is as follows:

$${F}_{1} = {F}_{T 1} + {F}_{N 1} + i \cdot {F}_{G} ,$$

where

F_{T1} denotes a valve spring force, F_{N1} denotes a part inertia force, F_{G} denotes a gas force, i denotes an air intake and exhaust indicator, i=0 indicates air intake, and i=1 indicates air exhaust;
S12, computing a gear transmission force: analyzing torque excitation of a tooth surface meshing force between gear pairs, and computing a gear meshing excitation force in a torsion direction;
S13, computing a valve cam pair contact friction force: evaluating a friction force and oil film performance of a cam pair through kinematics and friction and lubrication analysis; and
S14, computing valve cam load torque: computing load torque of a single valve camshaft on the basis of the force between the cam and the tappet and a force arm corresponding to the force.

Further, a computation formula of the valve spring force F_{T1} is as follows:

$${F}_{T 1} = {k}_{r} [ {F}_{01} + {k}_{s 1} \cdot {h}_{α1} ] ,$$

where
kᵣ denotes a rocker-arm ratio, F₀₁ denotes a valve spring pretightening force, kₛ₁ denotes valve spring stiffness, and h_{α1} denotes valve cam lift.

A computation formula of the part inertia force F_{N1} is as follows:

$${F}_{N 1} = {M}_{1} \cdot \frac{{d}^{2} {h}_{α1}}{{dt}^{2}} = {M}_{1} \cdot {ω}_{0}^{2} \cdot \frac{{d}^{2} {h}_{α1}}{d {α}^{2}} ,$$

where
M₁ denotes a lumped mass of the valve train, and ω₀ denotes a valve cam angular speed; and

A computation formula of the gas force F_{G} is as follows:

$${F}_{G} = \frac{π \cdot {d}_{v}^{2}}{4} \cdot {p}_{g} \cdot {10}^{5} ,$$

where
dᵥ denotes a valve disc diameter, and p_{g} denotes in-cylinder pressure.

Further, the computing a gear transmission force in S12 includes:
S121, obtaining comprehensive time-varying meshing stiffness of a gear meshing pair;
S122, analyzing a helical gear meshing excitation force;
S123, establishing a gear transmission error model through a simple harmonic function, where the gear transmission error model is expressed as:

$$e ( t ) = {e}_{0} sin ( 2 π {f}_{m} t + ϕ )$$

where
fₘ denotes gear meshing frequency, e₀ denotes a gear transmission error amplitude, and ϕ denotes an initial phase;
S124, establishing, in a case that transmission errors include a base pitch error f_{f} and a tooth profile error f_{pb}, a relation with the transmission error on the basis of a statistical principle, which is expressed as:

$${e}_{0} = ( {f}_{pb} + 2 {f}_{f} ) / \sqrt{2} ;$$

S125, computing a helical gear normal meshing force Fₙ through the comprehensive time-varying meshing stiffness of the gear meshing pair and transmission error excitation; and
S126, computing the gear meshing excitation force in the torsion direction, where a computation formula is as follows:

$${F}_{t} = {F}_{n} cos α cos β = {k}_{1} e ( t ) cos α cos β ,$$

where
Fₜ denotes a gear torsion-direction excitation force, k₁ denotes gear time-varying meshing stiffness, α denotes a tooth pressure angle, and β denotes a gear helical angle.

Further, the computing a valve cam pair contact friction force in S13 includes:
S131, conducting kinematic analysis: obtaining a valve cam curvature radius and a surface speed of a cam-tappet pair, and defining an instantaneous contact point P₁, where a computation process is as follows:
computing an instantaneous curvature radius: in a case that a follower is a flat-bottomed tappet, a computation formula of the valve cam curvature radius R₁ is:

$${R}_{1} = {R}_{11} + {h}_{α 1} + {h}_{α 1}^{″} ,$$

where
R₁ denotes the valve cam curvature radius, R₁₁ denotes a valve cam base radius,

$${h}_{α 1}^{″}$$

denotes a geometric acceleration, and

$${h}_{α 1}^{″} = {d}^{2} {h}_{α 1} / d {α}^{2} ;$$

ana
computing an instantaneous surface speed: computing a cam surface speed and a tappet surface speed according to a coordinate system, where a computation formula is as follows:

$$\begin{matrix}{u}_{11} = {ω}_{0} \cdot {R}_{1} \\ {u}_{12} = {ω}_{0} \cdot {h}_{α 1}^{″}\end{matrix} \} ,$$

where
u₁₁ denotes a valve cam surface speed, and u₁₂ denotes the tappet surface speed; and
S132, conducting friction and lubrication analysis: computing an oil film characteristic and friction excitation between valve cam pairs, where a computation process is as follows:

using a reynolds equation in consideration of an entrainment speed: considering a transient entrainment speed during the operation of the cam pair, and using a three-dimensional line contact elastohydrodynamic lubrication reynolds equation, where a computation formula is as follows:

$$\frac{\partial }{\partial x} ( \frac{ρ {h}^{3}}{12 η} \frac{\partial {p}_{f}}{\partial x} ) + \frac{\partial }{\partial y} ( \frac{ρ {h}^{3}}{12 η} \frac{\partial {p}_{f}}{\partial y} ) = u \frac{\partial ( ρ h )}{\partial x} + \frac{\partial ( ρ h )}{\partial t} ,$$

where
ρ_{f} denotes fluid pressure, h denotes an oil film thickness, n denotes a lubricating oil viscosity, ρ denotes a lubricating oil density, u denotes an entrainment speed between two surfaces, and u=(u₁₁+u₁₂)/2;

using a film thickness equation in consideration of a curvature radius, where for the cam pair, transient curvature is a factor influencing a contact film thickness, and an oil film thickness equation considering curvature change and elastic deformation is expressed as:

$$\begin{matrix}h ( x , y , t ) = {h}_{0} ( t ) + \frac{{x}^{2}}{2 {R}_{1}} + v ( x , y , t ) + δ ( x , y , t ) , and \\ v ( x , y , t ) = \frac{2}{π {E}^{′}} \int {\int }_{Ω} \frac{{p}_{f} ( ξ , ς ) + {p}_{c} ( ξ , ς )}{\sqrt{{( x - ξ )}^{2} + {( y - ς )}^{2}}} d ξ d ς ,\end{matrix}$$

where
h₀ denotes an initial film thickness, R₁ denotes a curvature radius, v (x, y, t) denotes an elastic deformation term, δ(x, y, t) denotes surface roughness distribution, p_{c} denotes rough contact pressure, E′ denotes a comprehensive elastic modulus, and ξ,ζ denotes an elastic deformation computation node; and
sinusoidal roughness having three-dimensional variable wavelengths in directions x and y is defined as:

$$δ ( x , y , t ) = {R}_{q} cos ( \frac{2 π x}{{w}_{x}} ) cos ( \frac{2 π y}{{w}_{y}} ) ,$$

where
R_{q} denotes a sinusoidal wave amplitude, and wₓ and w_{y} denote wavelengths in the directions x and y respectively;
using a bearing equation in consideration of contact load, where transient contact load between cam pairs is a factor that determines lubrication performance, and lubricating film bearing capacity and micro-convex bearing capacity have to be balanced with unit contact load between the cam pairs, which is expressed as:

$$\int \int [ {p}_{f} ( x , y , t ) + {p}_{c} ( x , y , t ) ] dxdy = {F}_{1} ,$$

where
p_{f} denotes fluid pressure, p_{c} denotes the rough contact pressure, and F₁ denotes a force between the cam and the tappet; and
using a friction equation in consideration of a rheological effect, where in an actual operation process of a cam pair interface, a coupling reaction may occur between some heat generated by friction and temperature, such that properties of lubricating oil change, and a computation formula is as follows:

$$\begin{matrix}\frac{u}{{G}_{∞}} \cdot \frac{d {τ}_{f}}{dx} - \frac{{τ}_{L}}{η} ln ( 1 - \frac{{τ}_{f}}{{τ}_{L}} ) - \frac{\vert {u}_{1} - {u}_{2} \vert}{h} = 0 \\ {G}_{∞} ( {p}_{f} , T ) = 1.2 {p}_{f} / ( 2.52 + 0.024 T ) - {10}^{- 9} \\ {τ}_{L} ( {p}_{f} , T ) = 0.25 {G}_{∞}\end{matrix} \} ,$$

where
τ_{f} denotes oil film shear stress, T denotes an interface temperature, σ denotes comprehensive surface roughness,

$$σ = \sqrt{{δ}_{1}^{2} + {δ}_{2}^{2}} ,$$

τ_{L} denotes ultimate shear stress, G_{∞} denotes an ultimate shear modulus, and lubricating oil performance parameters are functions of pressure and temperature;
when rough peak contact occurs, a friction coefficient of a rough contact zone is set as f, and a computation formula of shear stress at rough peak contact is: τ_{c}=f·ρ_{c};
total friction is a shear stress integral of the entire zone, which includes a fluid kinetic-pressure zone and a rough contact zone and configured to evaluate a friction characteristic in mixed elastohydrodynamic lubrication (EHL), where a computation formula is: F_{f1}=∫∫(τ_{f}+τ_{c}) dxdy; and
on the basis of a fast moving line contact heat source model and a second type of Volterra integral equation, a cam pair interface temperature computation model is established, which is expressed as:

$$\begin{matrix}{T}_{1} ( ξ ) = {T}_{b 1} + {( \frac{1}{π {ρ}_{1} {c}_{1} {u}_{1} {k}_{1}} )}^{0.5} \times \{ \frac{{k}_{f}}{h} [ {T}_{2} ( λ ) - {T}_{1} ( λ ) ] + \frac{q ( λ )}{2} \} \times \frac{d ( λ )}{{( ξ - λ )}^{05}} , and \\ {T}_{2} ( ξ ) = {T}_{b 2} + {( \frac{1}{π {ρ}_{2} {c}_{2} {u}_{2} {k}_{2}} )}^{0.5} \times \{ \frac{{k}_{f}}{h} [ {T}_{1} ( λ ) - {T}_{2} ( λ ) ] + \frac{q ( λ )}{2} \} \times \frac{d ( λ )}{{( ξ - λ )}^{05}} ,\end{matrix}$$

where

T₁ and T₂ denote surface temperatures of the cam and the tappet respectively, T_{b1} and T_{b2} denote initial surface temperatures, ρ₁ and ρ₂ denote a material density, c₁ and c₂ denote specific heat capacity of a material, k₁ and k₂ denote a thermal conductivity of a material, and k_{f} denotes a thermal conductivity of lubricating oil.

Further, a computation formula of the load torque of a single valve cam in S14 is as follows:

$${T}_{1} = {F}_{1} \cdot L + {F}_{f 1} \cdot ( {R}_{11} + {h}_{α 1} ) ,$$

where

L denotes a force arm of the force F₁ between the cam and the tappet, R₁₁+h_{α1} denotes a force arm of a friction force F_{f1}, and

$$L = \frac{{dh}_{a 1}}{da} .$$

Further, the computing torsional vibration of the valve camshaft system in S2 includes:

S21, conducting data collection: collecting the stiffness, the damping and the moment of inertia of the camshaft system, and defining the excitation condition of the valve cam load torque;

S22, conducting equation establishment: establishing a shaft system vibration differential equation on the basis of collected data and the excitation condition, where the shaft system vibration differential equation is expressed as: [J]{\ddot{ϕ}}+[C]{\dot{ϕ}}+[K]{<ϕ}={T}, where

[J] denotes a shaft system lumped-inertia matrix, [C] denotes a shaft system damping matrix, [K] denotes a shaft system stiffness matrix, {T}denotes an excitation vector, free vibration is indicated in response to {T}=0, and forced vibration is indicated in response to {T}≠0;

S23, conducting performance evaluation: analyzing friction lubrication performance of the cam pair at a steady rotational speed, analyzing torsional vibration of the camshaft system in consideration of excitation of a connecting gear system and in combination with structural parameters, stiffness-damping parameters and excitation torque of the camshaft system, and obtaining an influence degree of the friction excitation on shaft system torsional vibration; and

S24, conducting equation verification: analyzing, on the basis of rotational speed fluctuation of the cam pair obtained by the torsional vibration of the camshaft system, an influence degree of the rotational speed fluctuation on friction lubrication of the cam pair, and verifying accuracy of the shaft system vibration differential equation.

Further, the conducting comprehensive result analysis and influence evaluation in S3 includes:
S31, conducting valve cam pair contact analysis: analyzing change of a curvature radius and a surface speed of air intake and exhaust cam pairs on the basis of operation parameters including a base radius, a valve cam rotational speed, a spring pretightening force, spring stiffness and a lumped mass of a valve cam and tappet pair mechanism, and evaluating change of contact load between the cam and the tappet during air intake and exhaust;
S32, conducting valve cam pair friction and lubrication analysis: analyzing change of an oil film thickness and a friction force between a valve cam and tappet pair, computing a bonding temperature between lubricating oil and a cam material in consideration of influence of surface micro-roughness, and analyzing temperature rise of an air exhaust cam pair; and
S33, conducting valve camshaft system torsional vibration analysis: analyzing change of additional stress at a camshaft end caused by rotational speed fluctuation and friction excitation in consideration of change of load torque of an air intake and exhaust cam after the friction effect, analyzing influence of rotational speed fluctuation on the oil film thickness of the valve cam pair at base circle and peach tip positions, and evaluating a failure risk of interface bonding wear caused by rotational speed fluctuation on the basis of change of tappet interface temperature rise.

Further, a computation formula of the bonding temperature in S32 is as follows:

$${T}_{S} = 80 + ( 0.85 + 1.4 {X}_{W} ) \cdot {X}_{L} \cdot {( {S}_{F} )}^{2} ,$$

where
T_{S} denotes the bonding temperature, X_{W} denotes a material structure coefficient, X_{L} denotes a lubricating oil coefficient, and S_{F} denotes a load level when bonding occurs.

The present disclosure has beneficial effects:
According to the present disclosure, various mechanical effects and friction effects, such as the valve spring force, the part inertia force, the gas force and the friction force, in the camshaft system are comprehensively considered, such that the load torque of the camshaft can be computed more accurately. In addition, a kinetic behavior of the camshaft system can be understood more comprehensively by analyzing the gear transmission force and the cam pair contact friction force, and accuracy and reliability of kinetic analysis can be enhanced.

The present disclosure clearly defines the bonding temperature between lubricating oil and a cam material and its influence on system performance through friction and lubrication analysis, which is particularly important for optimizing design of the valve camshaft system and improving working efficiency and reliability of the system, especially for detailed analysis of temperature rise of the air exhaust cam pair, such that system failures caused by excessive temperature rise can be prevented.

According to the present disclosure, through deep analysis of the torsional vibration phenomenon of the valve camshaft system and the influence of the friction effect on the vibration characteristics, key factors that may lead to increased wear or failure can be identified, such as influence of rotational speed fluctuation on the oil film thickness and a failure risk of interface bonding wear. Such analysis results can provide scientific basis for maintenance and optimization of the system, which can reduce wear, reduce maintenance cost and prolong the service life of the valve camshaft system.

### BRIEF DESCRIPTION OF THE DRAWINGS

To describe technical solutions of the present disclosure or in the prior art more clearly, the accompanying drawings required for describing embodiments or the prior art will be briefly described below. Obviously, the accompanying drawings in the following description merely illustrate the present disclosure, and those of ordinary skill in the art can still derive other drawings from these accompanying drawings without inventive effort.

FIG. 1 is a simplified schematic diagram of a valve camshaft system according to an embodiment of the present disclosure.

FIG. 2 is a schematic analysis diagram of a force of a valve cam mechanism according to an embodiment of the present disclosure.

FIG. 3 is a schematic diagram of a curve of air intake and exhaust cam lift and cylinder pressure according to an embodiment of the present disclosure.

FIG. 4 is a schematic analysis diagram of a meshing excitation force of a gear pair according to an embodiment of the present disclosure.

FIG. 5 is a schematic diagram of kinematic analysis of a valve cam pair according to an embodiment of the present disclosure.

FIG. 6 is a schematic diagram of sinusoidal roughness of a three-dimensional variable wavelength according to an embodiment of the present disclosure.

FIG. 7 is a schematic flow diagram of kinetic analysis of friction of a cam pair shaft system according to an embodiment of the present disclosure.

FIG. 8 is a schematic diagram of kinematic change of air intake and exhaust cam pairs according to an embodiment of the present disclosure.

FIG. 9 is a schematic diagram of kinetic change of air intake and exhaust cam pairs according to an embodiment of the present disclosure.

FIG. 10 is a schematic diagram of film thickness and friction force change of a valve cam-tappet pair according to an embodiment of the present disclosure.

FIG. 11 is a schematic diagram of temperature rise change of surface friction of a tappet pair according to an embodiment of the present disclosure.

FIG. 12 is a schematic diagram of load torque of air intake and exhaust cams according to an embodiment of the present disclosure.

FIG. 13 is a schematic diagram of instantaneous rotational speed fluctuation of an air intake camshaft end according to an embodiment of the present disclosure.

FIG. 14 is a schematic diagram of instantaneous rotational speed fluctuation of an air exhaust camshaft end according to an embodiment of the present disclosure.

FIG. 15 is a schematic diagram of additional stress of a valve camshaft section according to an embodiment of the present disclosure.

FIG. 16 is a schematic diagram of film thickness change of a valve cam pair under instantaneous rotational speed fluctuation according to an embodiment of the present disclosure.

FIG. 17 is a schematic diagram of temperature rise of a tappet interface under instantaneous rotational speed fluctuation according to an embodiment of the present disclosure.

### DETAILED DESCRIPTION OF THE EMBODIMENTS

For making objectives, technical solutions and advantages of the present disclosure clearer, the present disclosure will be further described in detail below in conjunction with specific embodiments.

It should be noted that technical or scientific terms used in the present disclosure should have ordinary meanings as understood by those of ordinary skill in the art to which the present disclosure belongs, unless otherwise defined. “First”, “second”, and other similar words used in the present disclosure do not indicate any order, amount or importance, but are only used to distinguish different components. “Include”, “comprise”, “involve” and other similar words indicate that elements or objects before the word include elements or objects after the word and their equivalents, without excluding other elements or objects. “Connect”, “connected”, and other similar words are not limited to physical or mechanical connections, but may include electrical connections, which may be direct or indirect. “Upper”, “lower”, “left” and “right” are only used to indicate a relative positional relation. After an absolute position of the described object changes, the relative positional relation may also change accordingly.

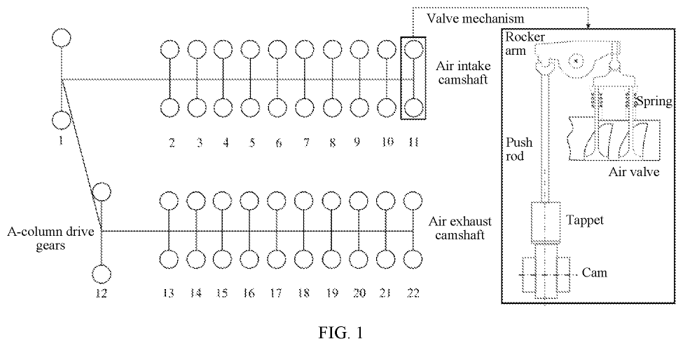

As shown in FIGS. 1-17, a kinetic analysis method for a marine valve camshaft system in consideration of a friction effect includes the following steps:
1, load torque of a camshaft is computed as follows:

A research object of the present disclosure is a valve train of a V20 diesel engine, in which a valve camshaft system is connected through a timing gear train. As shown in FIG. 1, a main function of the valve train is to control an air intake valve and an air exhaust valve to be opened and closed, so as to ensure normal operation of an engine under different working conditions. Main components of the valve train include: a cam, a tappet, a push rod, an air valve, and other parts. The parts work together to ensure that the diesel engine may exchange gas effectively at various rotational speeds and load conditions, so as to ensure performance and efficiency of the diesel engine.

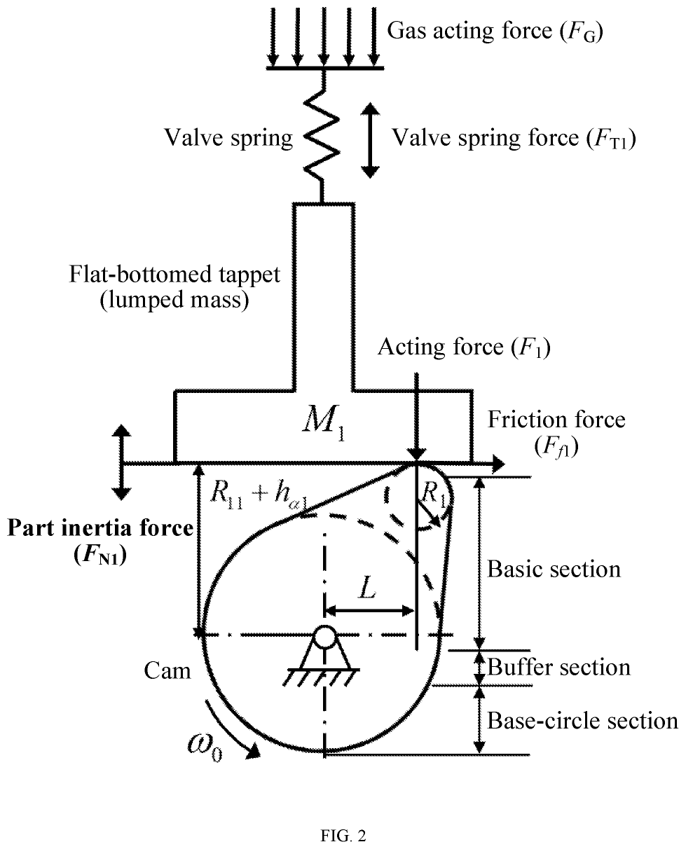

Gear mass system parameters required in a modeling process of a front-end gear transmission system include a moment of inertia, an excitation moment, etc. Modeling of the camshaft system involves the moment of inertia of a camshaft section and cam pair excitation. An equivalent parameter model of the camshaft system of the diesel engine is divided into 22 inertias. Inertias 1 and 12 are inertias of each gear, and inertias 2-11 and inertias 13-22 are inertias of a valve camshaft.
1.1, force of valve train:
During the operation of a valve train of a marine internal combustion engine, motion forms of various parts are complicated. In order to facilitate computation, masses of a tappet, a push rod, a rocker arm and an air valve are combined into a single mass M₁, as shown in FIG. 2.

For a solution of a force F₁ between a cam and the tappet, a valve spring force F_{T1}, a part inertia force F_{N1} and a gas force F_{G} are mainly involved. Specific solution formulas are as follows:

$${F}_{1} = {F}_{T 1} + {F}_{N 1} + i \cdot {F}_{G} \qquad ( 1 )$$

In the formula, F_{T1} denotes the valve spring force; F_{N1} denotes the part inertia force; F_{G} denotes the gas force; i denotes an air intake and exhaust indicator, i=0 indicates air intake, and i=1 indicates air exhaust.

$${F}_{T 1} = {k}_{r} [ {F}_{01} + {k}_{s 1} \cdot {h}_{α 1} ] \qquad ( 2 )$$

In the formula, kᵣ denotes a rocker-arm ratio; F₀₁ denotes a valve spring pretightening force; kₛ₁ denotes valve spring stiffness; and h_{α1} denotes valve cam lift.

$${F}_{N 1} = {M}_{1} \cdot \frac{{d}^{2} {h}_{α 1}}{{dt}^{2}} = {M}_{1} \cdot {ω}_{0}^{2} \cdot \frac{{d}^{2} {h}_{α 1}}{d {α}^{2}} \qquad ( 3 )$$

In the formula, M₁ denotes a lumped mass of the valve train, and ω₀ denotes a valve cam angular speed.

F_{G} denotes the gas force. In response to knowing in-cylinder gas pressure p_{g} and only considering that gas acts on a bottom surface of the air valve, change of the gas force may be obtained as follows:

$${F}_{G} = \frac{π \cdot {d}_{v}^{2}}{4} \cdot {p}_{g} \cdot {10}^{5} \qquad ( 4 )$$

In the formula, dᵥ denotes a valve disc diameter; and p_{g} denotes in-cylinder pressure.

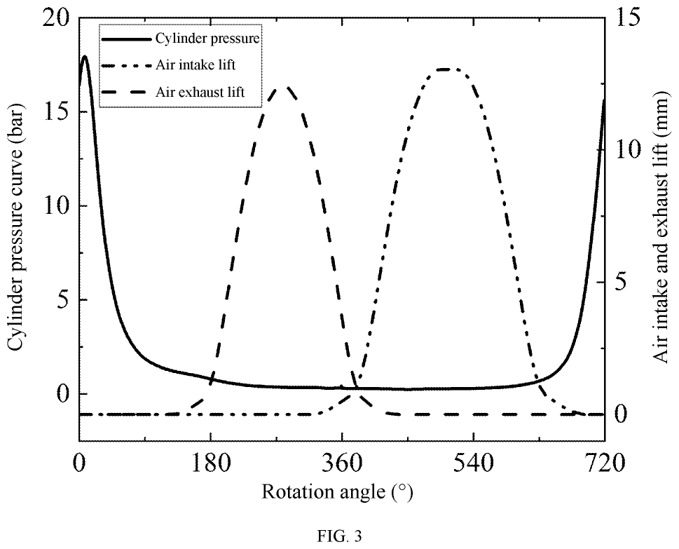

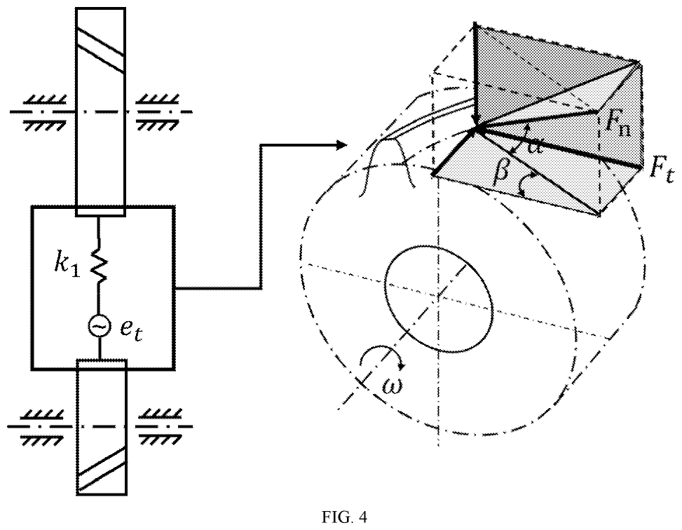

A curve of air intake and exhaust lift and cylinder pressure is as shown in FIG. 3.
1.2, gear transmission force:
A tooth surface meshing force acting between gear pairs is characterized by torque excitation in a torsion direction. A stiffness model may be modified according to a gear energy method based on wheel stiffness, and comprehensive time-varying meshing stiffness of a gear meshing pair may be obtained. The shaft system includes a helical gear pair, so a solution model of a helical gear meshing excitation force is established, as shown in FIG. 4.

A gear transmission error is established in a form of a simple harmonic function as follows:

$$e ( t ) = {e}_{0} sin ( 2 π {f}_{m} t + ϕ ) \qquad ( 5 )$$

In the formula, fₘ denotes gear meshing frequency, e₀ denotes a gear transmission error amplitude, and ϕ denotes an initial phase.

In a case that transmission errors mainly include a base pitch error f_{f} and a tooth profile error f_{pb}, a relation with the transmission error is established according to a statistical principle as follows:

$${e}_{0} = ( {f}_{pb} + 2 {f}_{f} ) / \sqrt{2} \qquad ( 6 )$$

A helical gear normal meshing force Fₙ may be obtained after gear time-varying meshing stiffness and transmission error excitation are established. Because of a helical angle of a helical gear, a meshing force generated acts on an end surface, in a radial direction, and in an axial direction. However, because the present disclosure only considers torsional vibration of the gear, a computation formula of a gear meshing excitation force in the torsion direction may be expressed as follows:

$${F}_{t} = {F}_{n} cos α cos β = {k}_{1} e ( t ) cos α cos β \qquad ( 7 )$$

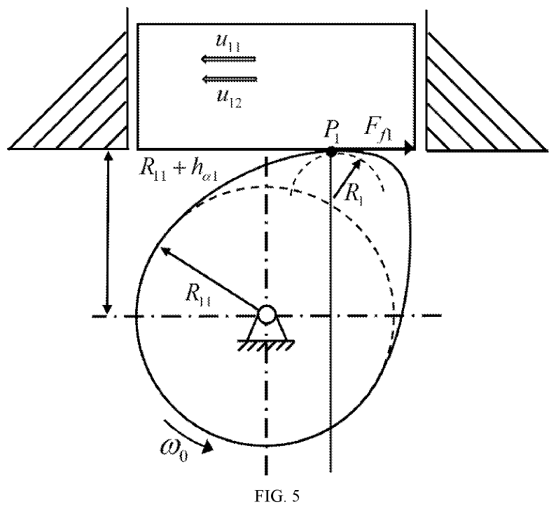

In the formula, Fₜ denotes a gear torsion-direction excitation force; k₁ denotes gear time-varying meshing stiffness; a denotes a tooth pressure angle; and β denotes a gear helical angle.
1.3, valve cam pair contact friction force:
1.3.1, kinematic analysis:
A kinematic analysis model of a cam and tappet pair shown in FIG. 5 is established to obtain a valve cam curvature radius and a surface speed of the cam and tappet pair. P₁ denotes an instantaneous contact point.
(1) Instantaneous curvature radius:
In a case that a follower is a flat-bottomed tappet, a computation formula of the valve cam curvature radius R₁ is as follows:

$${R}_{1} = {R}_{11} + {h}_{α 1} + {h}_{α 1}^{″} \qquad ( 8 )$$

In the formula, R₁ denotes the valve cam curvature radius; R₁₁ denotes a valve cam base radius;

$${h}_{α 1}^{″}$$

denotes a geometric acceleration, and

$${h}_{α 1}^{″} = {d}^{2} {h}_{α 1} / d {α}^{2} .$$

(2) Instantaneous surface speed:
From a coordinate system established in FIG. 5, a cam surface speed and a tappet surface speed are obtained as follows:

$$\begin{matrix}{u}_{11} & = {ω}_{0} \cdot {R}_{1} \\ {u}_{12} & = {ω}_{0} \cdot {h}_{α 1}^{″}\end{matrix} \} \qquad ( 9 )$$

In the formula, u₁₁ denotes a valve cam surface speed; and u₁₂ denotes the tappet surface speed.
1.3.2, friction and lubrication analysis:
According to a theory of linear contact mixed lubrication, a solution model of an instantaneous friction and lubrication characteristic of a cam pair is established to compute an oil film characteristic and friction excitation between valve cam pairs.
(1) Reynolds equation in consideration of an entrainment speed:
A transient entrainment speed during the operation of the cam pair is considered, and a three-dimensional line contact elastohydrodynamic lubrication reynolds equation is used as follows:

$$\frac{\partial }{\partial x} ( \frac{ρ {h}^{3}}{12 η} \frac{\partial {p}_{f}}{\partial x} ) + \frac{\partial }{\partial y} ( \frac{ρ {h}^{3}}{12 η} \frac{\partial {p}_{f}}{\partial y} ) = u \frac{\partial ( ρ h )}{\partial x} + \frac{\partial ( ρ h )}{\partial t} \qquad ( 10 )$$

In the equation, p_{f} denotes fluid pressure; h denotes an oil film thickness; η denotes a lubricating oil viscosity, which is computed through a Roelands viscosity formula; p denotes a lubricating oil density, which is computed through a Dowson-Higginson compaction formula; and u denotes an entrainment speed between two surfaces, and u=(u₁₁+u₁₂)/2.
(2) Film thickness equation in consideration of a curvature radius:
For the cam pair, complex transient curvature is an important factor influencing a contact film thickness, and oil film thickness equations considering curvature change and elastic deformation are as follows:

$$h ( x , y , t ) = {h}_{0} ( t ) + \frac{{x}^{2}}{2 {R}_{1}} + v ( x , y , t ) + δ ( x , y , t ) , and \qquad ( 11 )$$

$$v ( x , y , t ) = \frac{2}{π {E}^{′}} \int {\int }_{Ω} \frac{{p}_{f} ( ξ , ς ) + {p}_{c} ( ξ , ς )}{\sqrt{{( x - ξ )}^{2} + {( y - ς )}^{2}}} d ξ d ς \qquad ( 12 )$$

In the equations, h₀ denotes an initial film thickness; R₁ denotes a curvature radius; v(x, y, t) denotes an elastic deformation term; δ(x, y, t) denotes surface roughness distribution; p_{c} denotes rough contact pressure; E′ denotes a comprehensive elastic modulus, and ξ, ζ denotes an elastic deformation computation node. Discrete convolution and fast Fourier transform (DC-FFT) are used to compute elastic deformation a surface.

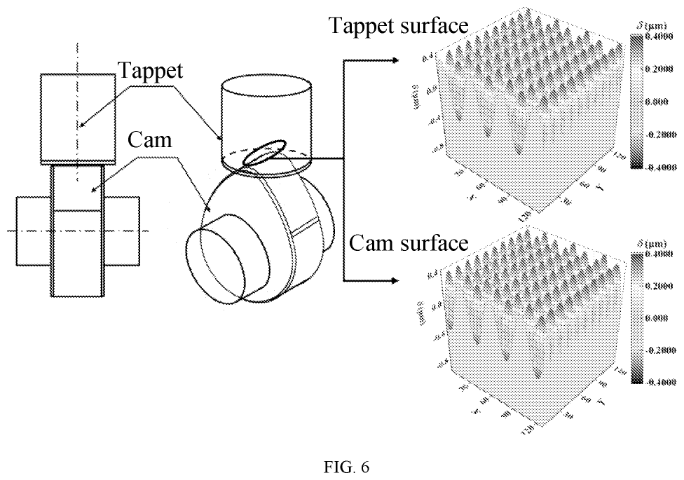

As shown in FIG. 6, sinusoidal roughness having three-dimensional variable wavelengths in directions x and y may be defined as:

$$δ ( x , y , t ) = {R}_{q} cos ( \frac{2 π x}{{w}_{x}} ) cos ( \frac{2 π y}{{w}_{y}} ) \qquad ( 13 )$$

In the formula, R_{q} denotes a sinusoidal wave amplitude; and wₓ and w_{y} denote wavelengths in the directions x and y respectively.
(3) Bearing equation in consideration of contact load:
Transient contact load between cam pairs is an important factor that determines lubrication performance, and lubricating film bearing capacity and micro-convex bearing capacity have to be balanced with unit contact load between the cam pairs.

$$\int {\int }_{Ω} [ {p}_{f} ( x , y , t ) + {p}_{c} ( x , y , t ) ] dxdy = {F}_{1} \qquad ( 14 )$$

In the formula, p_{f} denotes fluid pressure; P_{c} denotes the rough contact pressure; and F₁ denotes a force between the cam and the tappet.
(4) Friction equation in consideration of a rheological effect

During actual operation of a cam pair interface, a coupling reaction may occur between some heat generated by friction and temperature, such that properties of lubricating oil change. The present disclosure uses a Bair-Winer rheological model to solve an oil film friction force in a contact zone, and uses He to provide a modified Dowson model so as to predict ultimate shear stress.

$$\begin{matrix}\frac{u}{{G}_{∞}} \cdot \frac{d {τ}_{f}}{dx} - \frac{{τ}_{L}}{η} ln ( 1 - \frac{{τ}_{f}}{{τ}_{L}} ) - \frac{\vert {u}_{1} - {u}_{2} \vert}{h} & = 0 \\ {G}_{∞} ( {p}_{f} , T ) & = 1.2 {p}_{f} / ( 2.52 + 0.0 \; 24 T ) - {10}^{- 9} \\ {τ}_{L} ( {p}_{f} , T ) & = 0.25 {G}_{∞}\end{matrix} \} \qquad ( 15 )$$

In the formula, τ_{f} denotes oil film shear stress, T denotes an interface temperature, a denotes comprehensive surface roughness,

$$σ = \sqrt{{δ}_{1}^{2} + {δ}_{2}^{2}} ,$$

τ_{L} denotes ultimate shear stress, G_{∞} denotes an ultimate shear modulus, and lubricating oil performance parameters are functions of pressure and temperature.

When rough peak contact occurs, a friction coefficient of a rough contact zone may be assumed to be f, such that shear stress at a rough peak contact may be computed as follows: τ_{c}=f·p_{c}. Total friction is obtained through a shear stress integral of the entire zone, which includes a fluid kinetic-pressure zone and a rough contact zone and configured to evaluate a friction characteristic in mixed elastohydrodynamic lubrication (EHL).

$${F}_{f 1} = \int \int ( {τ}_{f} + {τ}_{c} ) dxdy \qquad ( 16 )$$

On the basis of a fast moving line contact heat source model and a second type of Volterra integral equation, a cam pair interface temperature computation model is established.

$${T}_{1} ( ξ ) = {T}_{b 1} + {( \frac{1}{π {ρ}_{1} {c}_{1} {u}_{1} {k}_{1}} )}^{0.5} \times \{ \frac{{k}_{f}}{h} [ {T}_{2} ( λ ) - {T}_{1} ( λ ) ] + \frac{q ( λ )}{2} \} \times \frac{d ( λ )}{{( ξ - λ )}^{0.5}} , and \qquad ( 17 )$$

$${T}_{2} ( ξ ) = {T}_{b 2} + {( \frac{1}{π {ρ}_{2} {c}_{2} {u}_{2} {k}_{2}} )}^{0.5} \times \{ \frac{{k}_{f}}{h} [ {T}_{1} ( λ ) - {T}_{2} ( λ ) ] + \frac{q ( λ )}{2} \} \times \frac{d ( λ )}{{( ξ - λ )}^{0.5}} \qquad ( 18 )$$

In the formulas, T₁ and T₂ denote surface temperatures of the cam and the tappet respectively; T_{b1} and T_{b2} denote initial surface temperatures; ρ₁ and ρ₂ denote material densities; c₁ and c₂ denote material specific heat capacities; k₁ and k₂ denote material thermal conductivities; and k_{f} denotes a thermal conductivity of lubricating oil.
1.4, valve cam load torque:
During rotation of a valve camshaft, a contact point between a valve cam and a follower is constantly changing due to intermittent opening/closing of an air valve of a valve cam and limitation of factors such as a geometrical shape of a cam and a valve phase, such that load torque has kinetic influence on the camshaft.

When load torque of an air intake/exhaust cam is computed, modules are consistent, but an air valve of an air exhaust valve system needs to be loaded with combustion pressure. Load torque of the air intake/exhaust valve train mainly comes from an inertia force, a spring force, a gas force, and a friction force, without considering an elastic counter-force and a damping force of an air valve seat when the air valve is seated.

It can be seen from FIG. 2 that L denotes a force arm of a force F₁ between a cam and a tappet, R₁₁+h_{α1} denotes a force arm of a friction force F_{f1}, and

$$L = \frac{{dh}_{α 1}}{d α} .$$

Therefore, according to the computed force between the cam and the tappet and the force arm corresponding to the force, load torque of a single valve cam is obtained as follows:

$${T}_{1} = {F}_{1} \cdot L + {F}_{f 1} \cdot ( {R}_{11} + {h}_{α 1} ) \qquad ( 19 )$$

A research object of the present disclosure is a valve camshaft system of a V20 diesel engine. During actual working, torque of each cam pair changes due to different firing orders of all cylinders. Therefore, the firing order has to be considered in torsional vibration computation. In order to facilitate expression of a friction and lubrication state and excitation torque changes of each air intake and exhaust cam pair, only one group of air intake and exhaust cam pair torque changes is provided below. For the research object V20 diesel engine, with an air intake cam pair as an example, a firing order is [1 2 4 6 8 10 9 7 5 3], (the one close to a flywheel end is defined as 1).
2, torsional vibration of a valve camshaft system is computed:
According to known parameters such as stiffness, damping and a moment of inertia of each part of the camshaft, and on the basis of a load torque excitation condition of a valve cam, a torsional vibration analysis model of the valve camshaft system of the diesel engine is established. A differential equation of shaft system vibration is as follows:

$$[ J ] \{ \ddot{ϕ} \} + [ C ] \{ \dot{ϕ} \} + [ K ] \{ ϕ \} = \{ T \} \qquad ( 20 )$$

In the equation, [J] denotes a lumped inertia matrix of a shaft system; [C] denotes a damping matrix of the shaft system; [K] denotes a stiffness matrix of the shaft system; and {T}denotes an excitation vector acting on the system. When {T}=0, the system vibrates freely, and a modal and a vibration of the shaft system may be computed. When {T}≠0, the system is forced to vibrate, and various internal excitations of the diesel engine are involved. Therefore, a Newmark step-by-step integration algorithm is used to analyze forced vibration of the valve camshaft system.

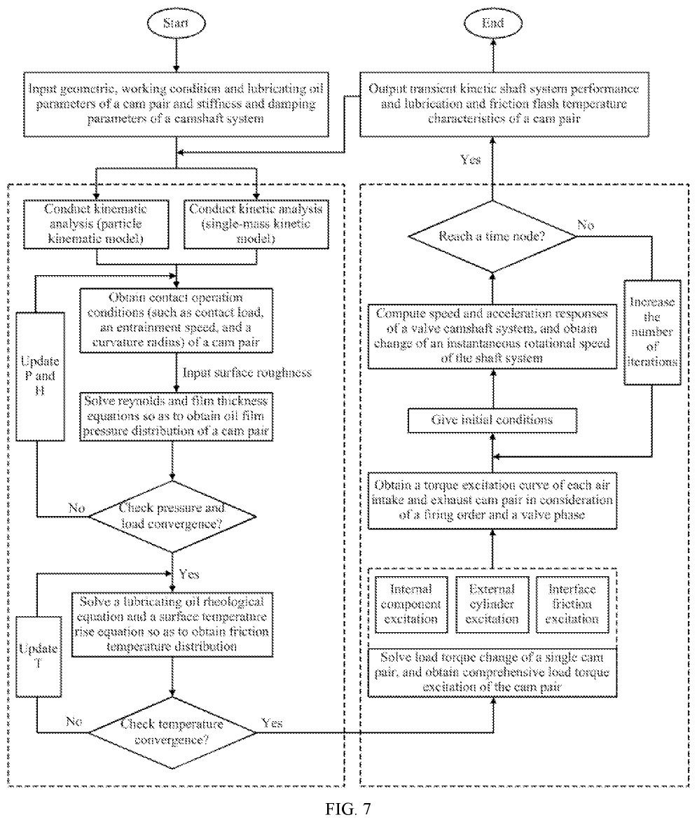

With regard to friction kinetic analysis of a complex cam pair shaft system, the main idea is as follows: for air intake and exhaust cam pairs, which have consistent mechanism distribution and profile data, firstly, a motion and kinetic characteristic analysis model of a single cam pair is established, and on the basis of a three-dimensional linear contact mixed lubrication model, friction and lubrication performance of the cam pair at a steady rotational speed is obtained, which provides input conditions for subsequent kinetic computation; further, on the basis of a cam pair load torque computation model established, change of comprehensive load torque of the single cam pair is analyzed, and due to different firing orders between all cylinders, a valve phase is considered in torque computation of each air intake and exhaust cam pair in combination with the firing order; then, a camshaft system torsional vibration analysis model is established, an excitation effect of a connecting gear system is considered, and in combination with a structural parameter, a stiffness damping parameter and excitation torque of the camshaft system, the torsional vibration of the camshaft system is analyzed to obtain an influence degree of friction excitation on shaft system torsional vibration; and finally, on the basis of rotational speed fluctuation of the cam pair obtained from the torsional vibration of the camshaft system, and in combination with a cam pair friction and lubrication analysis model established, an influence degree of rotational speed fluctuation on friction and lubrication of the cam pair is analyzed, and model accuracy is ensured by comparing a kinetic test of the valve camshaft system.
3, results and discussion:
3.1, valve cam pair contact analysis:
Operation parameters of a valve cam and tappet pair mechanism are given, as shown in Table 1. Further, changes of kinematic and kinetic parameters during operation of an air intake and exhaust cam and tappet pair are obtained, as shown in FIG. 7.

TABLE 1
Cam-tappet pair operation parameters

| Name | Unit | Number |
|---|---|---|
| Base radius | mm | 32 |
| Rotational speed of valve cam | r/min | 845 |
| Spring pretightening force | N | 648 |
| Spring stiffness | N/mm | 32 |
| Lumped mass | kg | 1.429 |

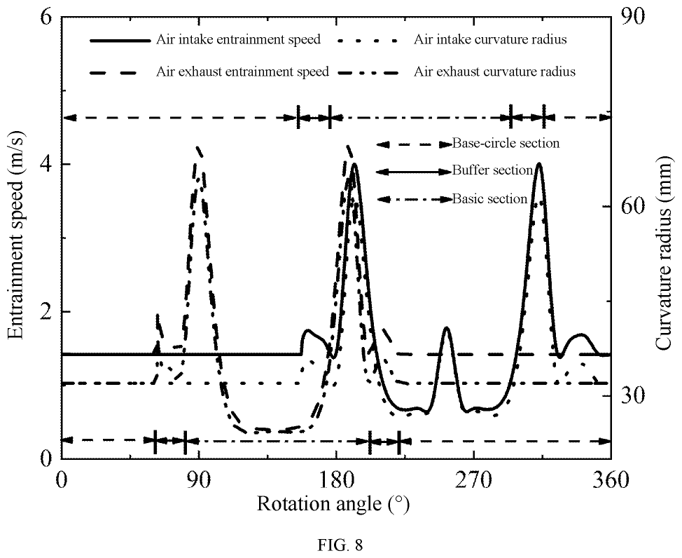

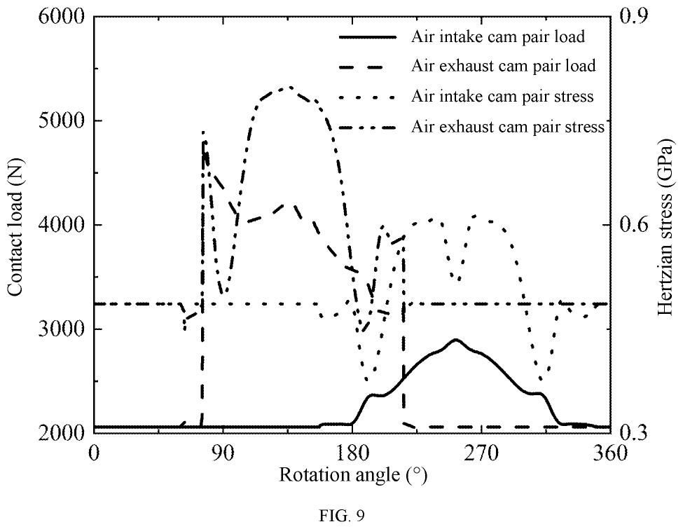

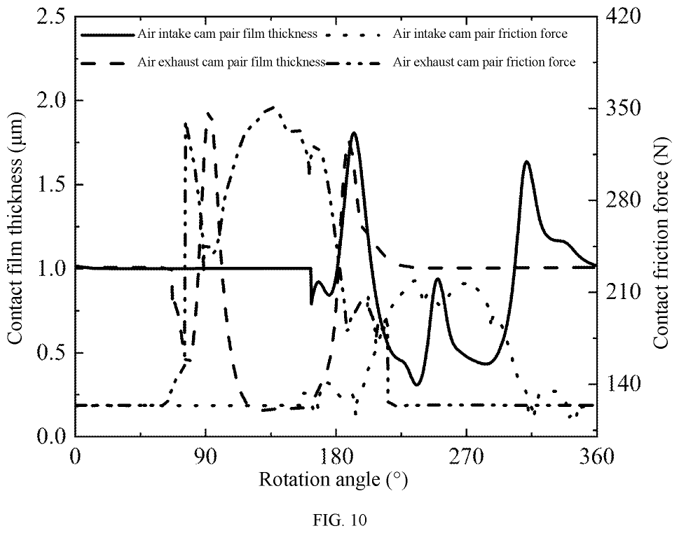

It can be seen from FIG. 8 that for a curvature radius and an entrainment speed of an air intake and exhaust cam pair, especially when the cam pair enters a basic section from a buffer section, the values decrease from a maximum value to a minimum value, resulting in a sharp change in a surface motion state. It can be seen from FIG. 9 that when a valve train of the diesel engine operates, contact load between air intake cam and tappet reaches a maximum value at a “peach-tip” position, and contact stress is about 0.5 GPa due to a large curvature radius; and an air exhaust cam-tappet pair has maximum instantaneous load when an air valve is opened due to influence of exhaust pressure, and has contact stress about 0.8 GPa at a “peach-tip” position.
3.2, valve cam pair friction and lubrication analysis:
FIG. 10 illustrates film thickness and friction force changes of a valve cam and tappet pair. The results show that a minimum film thickness of an air intake cam pair is 0.30 μm and a minimum film thickness of an air exhaust cam pair is 0.157 μm due to influence of surface microroughness. Air intake and exhaust friction forces both reach maximum values near a peach-tip position, and a friction force of an air exhaust cam pair is ranged from 120 N to 350 N, which is about 135 N greater than a surface friction force of the air intake cam pair, which has greater contact load under gas pressure.

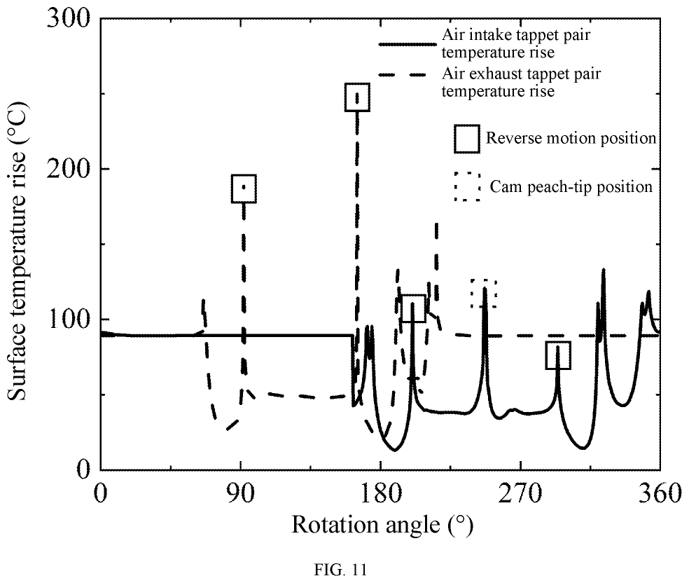

FIG. 11 shows friction temperature rise on a surface of a tappet pair. It can be seen from the figure that maximum temperature rise on a surface of a tappet changes sharply during the operation of a cam and tappet pair, and an extremely high temperature point exists at a position where a surface speed is zero (a reverse motion position) and at a peach-tip position of the cam. There are two main reasons for extremely high temperature rise at the above positions: (1) when the temperature rise occurs at a position where a surface speed of a tappet is 0, lubricating oil cannot carry heat in time; (2) when the temperature rise occurs at a position where a motion state of a tappet surface changes, a slide-roll state between the cam and the tappet changes violently, resulting in excessive friction heat.

With reference to a first part of a national standard for computing bonding bearing capacity of a cylindrical gear: a flash temperature method (GB-T6413.1-2003) is used to evaluate the bonding bearing capacity of the air intake and exhaust cam pair. Whether the cam pair is bonded is not only related to surface temperature, but also closely related to a cam material and a lubricating oil characteristic. However, a national-standard flash temperature method for computing the bonding bearing capacity stipulates that bonding temperature of lubricating oil and a material system has a specific value T_{S}, which may be computed through an empirical formula:

$${T}_{S} = 80 + ( 0.85 + 1.4 {X}_{W} ) \cdot {X}_{L} \cdot {( {S}_{F} )}^{2} \qquad ( 21 )$$

In the formula, T_{S} denotes the bonding temperature; X_{W} denotes a material structure coefficient, where the material structure coefficient after carbonization is selected according to an average value (10%-20%) of carburized and quenched steel, and X_{W}=1.0; X_{L} denotes a lubricating oil coefficient, which may be computed through the following formula: X_{L}=1.1η^{-0.05}; and S_{F} denotes a load level when bonding occurs, and the bonding load level varies from 8 to 11, an intermediate value of which is selected as S_{F}=9.5.

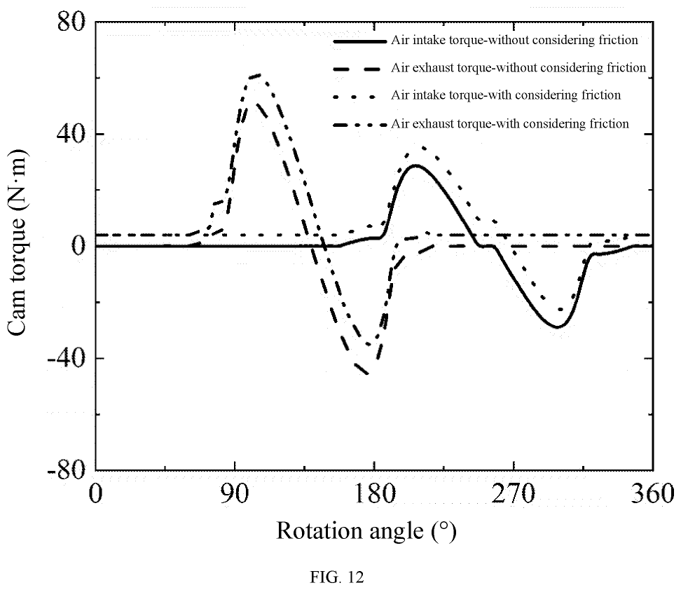

Through the above empirical formula, it can be found that the bonding temperature is 331.5° C., and the computed temperature rise of the air exhaust cam pair is about 251° C., which is smaller than the bonding temperature, so a risk of bonding failure is low.
3.3, torsional vibration analysis of a valve camshaft system:
FIG. 12 shows changes of load torque of air intake and exhaust cams in consideration of a friction effect in an operation period. In this case, it is noted that the load torque is not completely zero during contact between a cam base circle and a tappet due to existence of a friction force.

It can also be seen from FIG. 12 that a moment generated by a force has a greatest contribution, an acting moment in a normal direction may change its direction at a vertex of a cam profile, and accordingly, a contact point between the cam and the tappet moves from one side of an axis to the other side; and a direction of a friction moment is unchanged, and a total moment value is increased by the friction moment in a lift stage and decreased by the friction moment in a drop stage.

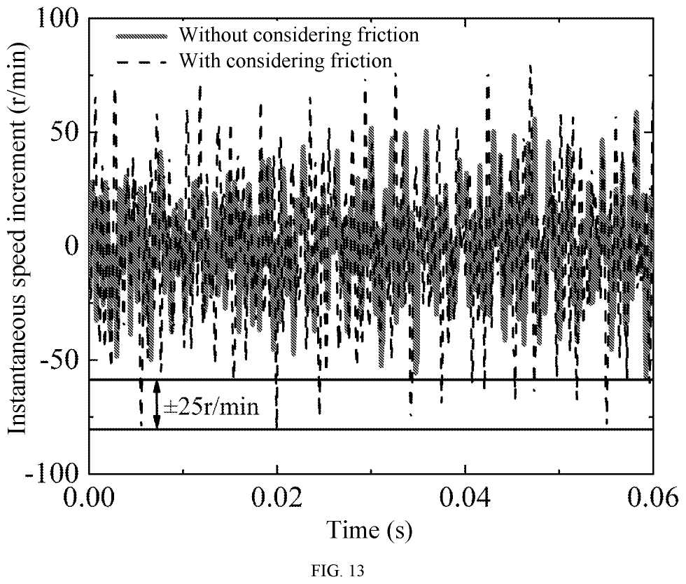

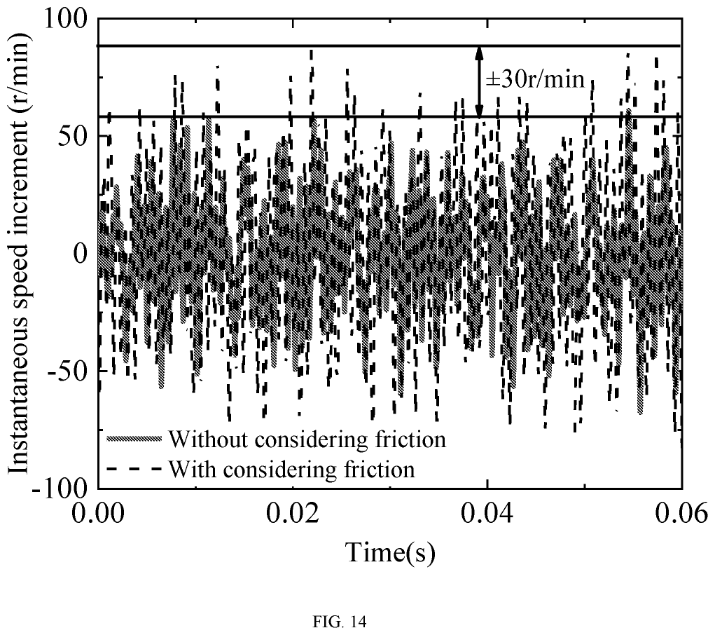

FIG. 13 and FIG. 14 show instantaneous speed fluctuation of a valve camshaft end (inertia 11 and inertia 22). It can be seen from the figure that positions with a great rotational speed and rotation range of the valve camshaft system are mainly concentrated at an end of the shaft system, that is, far away from a gear, and rotational speed fluctuation of the air exhaust camshaft end can be increased by ±30 r/min in consideration of friction excitation.

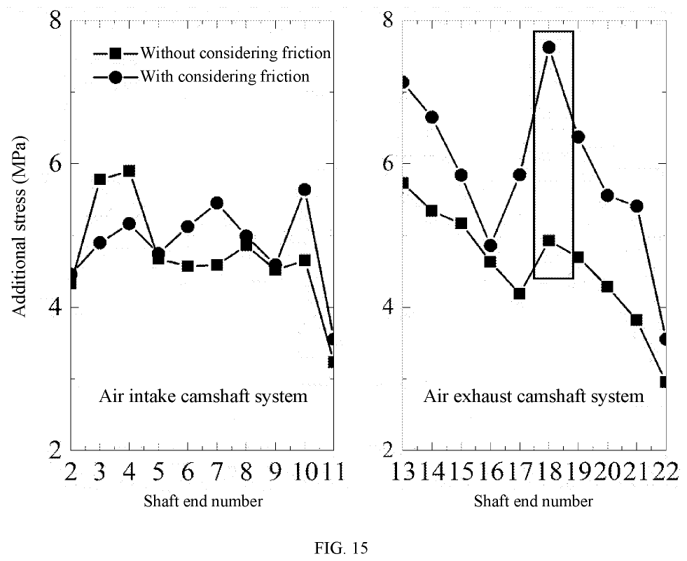

The above analysis indicates that due to influence of torsional vibration of the shaft system, a relative change exists in rotational speed between all camshafts, which will lead to additional torque on the shaft system, and then generate corresponding additional stress at a shaft end. FIG. 15 shows variation of additional stress of a valve camshaft section. By comparing additional stress of two camshafts, it can be found that an additional stress level of an air exhaust camshaft is higher, which has a poorer torsional vibration characteristic than an air intake camshaft. In consideration of interface friction excitation, additional stress of the valve camshaft end increases by about 4 MPa.

Obvious speed fluctuation occurs during the operation of the camshaft system, which will lead to instantaneous fluctuation in entrainment speeds of cam and tappet surfaces. Further, in consideration of instantaneous speed change of a valve cam pair, which is substituted into a friction and lubrication model of a cam pair, oil film thickness change of the valve cam pair under the instantaneous speed fluctuation is obtained.

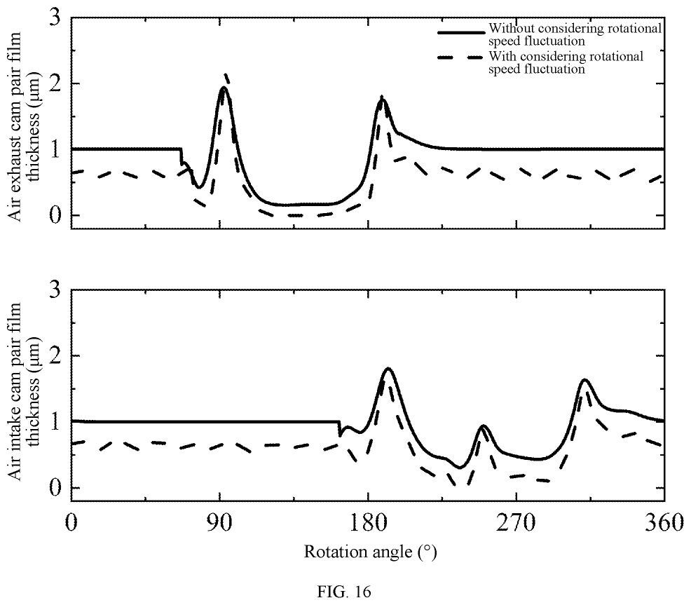

A three-dimensional sinusoidal surface is taken into account in friction and lubrication of the cam pair without considering rotational speed fluctuation and with considering rotational speed fluctuation analysis. Therefore, FIG. 16 mainly compares influence of rotational speed fluctuation on the oil film thickness change of the valve cam pair. It can be seen from the figure that comprehensive influence of entrainment speed change caused by rotational speed fluctuation and roughness can reduce an oil film thickness by about 0.3 m, and especially in a base circle section, even zero film thickness appears at the peach-tip position, resulting in a sharp deterioration of the oil film thickness between the cam and tappet pair.

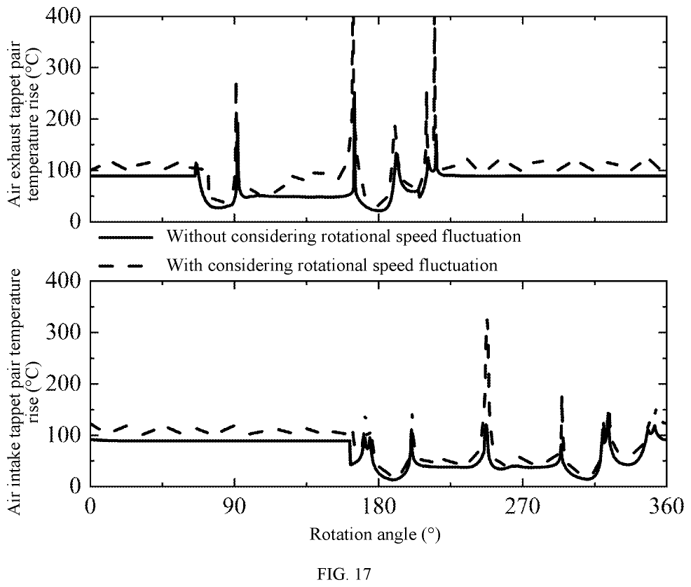

FIG. 17 shows temperature rise at a tappet interface under instantaneous speed fluctuation, and evaluates a degree of interface bonding failure through surface temperature rise. Rotational speed fluctuation causes decrease in oil film thickness between valve cam pairs, and a surface slide-roll ratio changes sharply, such that temperature rise of a tappet pair exceeds a material bonding limit at a reverse motion position of the cam pair and at the peach-tip position, and a risk of interface bonding wear failure increases.

Those of ordinary skill in the art should understand that discussion of any one of the embodiments is only illustrative, and is not intended to imply that the scope of the present disclosure is limited to the examples. In consideration of the idea of the present disclosure, technical features in the above embodiments or different embodiments may also be combined, and the steps may be implemented in any order. Many other variations exist in different aspects of the present disclosure as described above, which are not provided in details for brevity.

The present disclosure is intended to cover all such substitutions, modifications and variations that fall within the broad scope of claims. Therefore, any omission, modification, equivalent substitution, improvement, etc. within the spirit and principle of the present disclosure shall fall within the protection scope of the present disclosure.

What is claimed is:

1. A kinetic analysis method for a marine valve camshaft system in consideration of a friction effect, comprising the following steps:
S1, computing load torque of a camshaft: computing the load torque borne by the camshaft during the operation on the basis of composition and an operation condition of a valve train;
S2, computing torsional vibration of the valve camshaft system: analyzing, on the basis of an excitation condition of the load torque of the valve camshaft, a torsional vibration phenomenon of the camshaft system and influence of the friction effect on vibration characteristics in combination with physical properties comprising stiffness, damping and a moment of inertia of the camshaft system; and
S3, conducting comprehensive result analysis and influence evaluation: comprehensively analyzing and evaluating a torsional vibration result, and paying attention to influence of the friction effect on the camshaft system.

2. The kinetic analysis method for a marine valve camshaft system in consideration of a friction effect according to claim 1, wherein the computing load torque of a camshaft in S1 comprises:
S11, computing the force of the valve train: computing a force F₁ between a cam and a tappet, wherein a computation formula is as follows:
$${F}_{1} = {F}_{T 1} + {F}_{N 1} + i \cdot {F}_{G} ,$$
wherein
F_{T1} denotes a valve spring force, F_{N1} denotes a part inertia force, F_{G} denotes a gas force, i denotes an air intake and exhaust indicator, i=0 indicates air intake, and i=1 indicates air exhaust;
S12, computing a gear transmission force: analyzing torque excitation of a tooth surface meshing force between gear pairs, and computing a gear meshing excitation force in a torsion direction;
S13, computing a valve cam pair contact friction force: evaluating a friction force and oil film performance of a cam pair through kinematics and friction and lubrication analysis; and
S14, computing valve cam load torque: computing load torque of a single valve camshaft on the basis of the force between the cam and the tappet and a force arm corresponding to the force.

3. The kinetic analysis method for a marine valve camshaft system in consideration of a friction effect according to claim 2, wherein a computation formula of the valve spring force F_{T1} is as follows:
$${F}_{T 1} = {k}_{r} [ {F}_{01} + {k}_{s 1} \cdot {h}_{α 1} ] ,$$
kᵣ denotes a rocker-arm ratio, F₀₁ denotes a valve spring pretightening force, kₛ₁ denotes valve spring stiffness, and hₐi denotes valve cam lift;
a computation formula of the part inertia force F_{N1} is as follows:
$${F}_{N 1} = {M}_{1} \cdot \frac{{d}^{2} {h}_{α 1}}{{dt}^{2}} = {M}_{1} \cdot {ω}_{0}^{2} \cdot \frac{{d}^{2} {h}_{α 1}}{d {α}^{2}} ,$$
M₁ denotes a lumped mass of the valve train, and ω₀ denotes a valve cam angular speed; and
a computation formula of the gas force F_{G} is as follows:
$${F}_{G} = \frac{π \cdot {d}_{v}^{2}}{4} \cdot {p}_{g} \cdot {10}^{5} ,$$
wherein
dᵥ denotes a valve disc diameter, and p_{g} denotes in-cylinder pressure.

4. The kinetic analysis method for a marine valve camshaft system in consideration of a friction effect according to claim 3, wherein the computing a gear transmission force in S12 comprises:
S121, obtaining comprehensive time-varying meshing stiffness of a gear meshing pair;
S122, analyzing a helical gear meshing excitation force;
S123, establishing a gear transmission error model through a simple harmonic function, wherein the gear transmission error model is expressed as:
$$e ( t ) = {e}_{0} sin ( 2 π {f}_{m} t + ϕ ) ,$$
wherein
fₘ denotes gear meshing frequency, e₀ denotes a gear transmission error amplitude, and ϕ denotes an initial phase;
S124, establishing, in a case that transmission errors include a base pitch error f_{f} and a tooth profile error f_{pb}, a relation with the transmission error on the basis of a statistical principle, which is expressed as:
$${e}_{0} = ( {f}_{pb} + 2 {f}_{f} ) / \sqrt{2} ;$$
S125, computing a helical gear normal meshing force Fₙ through the comprehensive time-varying meshing stiffness of the gear meshing pair and transmission error excitation; and
S126, computing the gear meshing excitation force in the torsion direction, wherein a computation formula is as follows:
$${F}_{t} = {F}_{n} cos α cos β = {k}_{1} e ( t ) cos α cos β ,$$
Fₜ denotes a gear torsion-direction excitation force, k₁ denotes gear time-varying meshing stiffness, a denotes a tooth pressure angle, and β denotes a gear helical angle.

5. The kinetic analysis method for a marine valve camshaft system in consideration of a friction effect according to claim 4, wherein the computing a valve cam pair contact friction force in S13 comprises:
S131, conducting kinematic analysis: obtaining a valve cam curvature radius and a surface speed of a cam-tappet pair, and defining an instantaneous contact point P₁, wherein a computation process is as follows:
computing an instantaneous curvature radius: in a case that a follower is a flat-bottomed tappet, a computation formula of the valve cam curvature radius R₁ is:
$${R}_{1} = {R}_{11} + {h}_{α 1} + {h}_{α1}^{″} ,$$
wherein
R₁ denotes the valve cam curvature radius, R₁₁ denotes a valve cam base radius,
$${h}_{α1}^{″}$$
denotes a geometric acceleration, and
$${h}_{α1}^{″} = {d}^{2} {h}_{α 1} / d {α}^{2} ;$$
and
computing an instantaneous surface speed: computing a cam surface speed and a tappet surface speed according to a coordinate system, wherein a computation formula is as follows:
$$\begin{matrix}{u}_{11} & = {ω}_{0} \cdot {R}_{1} \\ {u}_{12} & = {ω}_{0} \cdot {h}_{α1}^{″}\end{matrix} \} ,$$
wherein
u₁₁ denotes a valve cam surface speed, and u₁₂ denotes the tappet surface speed; and
S132, conducting friction and lubrication analysis: computing an oil film characteristic and friction excitation between valve cam pairs, wherein a computation process is as follows:
using a reynolds equation in consideration of an entrainment speed: considering a transient entrainment speed during the operation of the cam pair, and using a three-dimensional line contact elastohydrodynamic lubrication reynolds equation, wherein a computation formula is as follows:
$$\frac{\partial }{\partial x} ( \frac{ρ {h}^{3}}{12 η} \frac{\partial {p}_{f}}{\partial x} ) + \frac{\partial }{\partial y} ( \frac{ρ {h}^{3}}{12 η} \frac{\partial {p}_{f}}{\partial y} ) = u \frac{\partial ( ρ h )}{\partial x} + \frac{\partial ( ρ h )}{\partial t} ,$$
wherein
p_{f} denotes fluid pressure, h denotes an oil film thickness, η denotes a lubricating oil viscosity, ρ denotes a lubricating oil density, u denotes an entrainment speed between two surfaces, and u=(u₁₁+u₁₂)/2;
using a film thickness equation in consideration of a curvature radius, wherein for the cam pair, transient curvature is a factor influencing a contact film thickness, and an oil film thickness equation considering curvature change and elastic deformation is expressed as:
$$h ( x , y , t ) = {h}_{0} ( t ) + \frac{{x}^{2}}{2 {R}_{1}} + v ( x , y , t ) + δ ( x , y , t ) , and$$
$$v ( x , y , t ) = \frac{2}{π {E}^{′}} \int {\int }_{Ω} \frac{{p}_{f} ( ξ , ς ) + {p}_{c} ( ξ , ς )}{\sqrt{{( x - ξ )}^{2} + {( y - ϛ )}^{2}}} d ξ d ς ,$$
wherein
h₀ denotes an initial film thickness, R₁ denotes a curvature radius, v(x,y, t) denotes an elastic deformation term, δ(x,y, t) denotes surface roughness distribution, p_{c} denotes rough contact pressure, E′ denotes a comprehensive elastic modulus, and ξ, ζ denotes an elastic deformation computation node; and
sinusoidal roughness having three-dimensional variable wavelengths in directions x and y is defined as:
$$δ ( x , y , t ) = {R}_{q} cos ( \frac{2 π x}{{w}_{x}} ) cos ( \frac{2 π y}{{w}_{y}} ) ,$$
R_{q} denotes a sinusoidal wave amplitude, and wₓ and w_{y} denote wavelengths in the directions x and y respectively;
using a bearing equation in consideration of contact load, wherein transient contact load between cam pairs is a factor that determines lubrication performance, and lubricating film bearing capacity and micro-convex bearing capacity have to be balanced with unit contact load between the cam pairs, which is expressed as:
$$\int {\int }_{Ω} [ {p}_{f} ( x , y , t ) + {p}_{c} ( x , y , t ) ] dxdy = {F}_{1} ,$$
p_{f} denotes fluid pressure, p_{c} denotes the rough contact pressure, and F₁ denotes a force between the cam and the tappet; and
using a friction equation in consideration of a rheological effect, wherein in an actual operation process of a cam pair interface, a coupling reaction may occur between some heat generated by friction and temperature, such that properties of lubricating oil change, and a computation formula is as follows:
$$\begin{matrix}\frac{u}{{G}_{∞}} \cdot \frac{d {τ}_{f}}{dx} - \frac{{τ}_{L}}{η} ln ( 1 - \frac{{τ}_{f}}{{τ}_{L}} ) - \frac{\vert {u}_{1} - {u}_{2} \vert}{h} & = 0 \\ {G}_{∞} ( {p}_{f} , T ) & = 1.2 {p}_{f} / ( 2.52 + 0.0 \; 24 T ) - 1 {0}^{- 9} \\ {τ}_{L} ( {p}_{f} , T ) & = 0.25 {G}_{∞}\end{matrix} \} ,$$
τ_{f} denotes oil film shear stress, T denotes an interface temperature, σ denotes comprehensive surface roughness,
$$σ = \sqrt{{δ}_{1}^{2} + {δ}_{2}^{2}} ,$$
τ_{L} denotes ultimate shear stress, G, denotes an ultimate shear modulus, and lubricating oil performance parameters are functions of pressure and temperature;
when rough peak contact occurs, a friction coefficient of a rough contact zone is set as f, and a computation formula of shear stress at rough peak contact is: τ_{c}=f·p_{c};
total friction is a shear stress integral of the entire zone, which comprises a fluid kinetic-pressure zone and a rough contact zone and configured to evaluate a friction characteristic in mixed elastohydrodynamic lubrication (EHL), wherein a computation formula is: F_{f1}=∫∫(τ_{f}+τ_{c})dxdy; and
based on a fast moving line contact heat source model and a second type of Volterra integral equation, a cam pair interface temperature computation model is established, and is expressed as:
$${T}_{1} ( ξ ) = {T}_{b 1} + {( \frac{1}{π {ρ}_{1} {c}_{1} {u}_{1} {k}_{1}} )}^{0.5} \times \{ \frac{{k}_{f}}{h} [ {T}_{2} ( λ ) - {T}_{1} ( λ ) ] + \frac{q ( λ )}{2} \} \times \frac{d ( λ )}{{( ξ - λ )}^{0.5}} , and$$
$${T}_{2} ( ξ ) = {T}_{b 2} + {( \frac{1}{π {ρ}_{2} {c}_{2} {u}_{2} {k}_{2}} )}^{0.5} \times \{ \frac{{k}_{f}}{h} [ {T}_{1} ( λ ) - {T}_{2} ( λ ) ] + \frac{q ( λ )}{2} \} \times \frac{d ( λ )}{{( ξ - λ )}^{0.5}} ,$$
wherein
T₁ and T₂ denote surface temperatures of the cam and the tappet respectively, T_{b1} and T_{b2} denote initial surface temperatures, ρ₁ and ρ₂ denote material densities, c₁ and c₂ denote material specific heat capacities, k₁ and k₂ denote material thermal conductivities, and k_{f} denotes a thermal conductivity of lubricating oil.

6. The kinetic analysis method for a marine valve camshaft system in consideration of a friction effect according to claim 5, wherein a computation formula of the load torque of a single valve cam in S14 is as follows:
$${T}_{1} = {F}_{1} \cdot L + {F}_{f 1} \cdot ( {R}_{11} + {h}_{α 1} ) ,$$
wherein
L denotes a force arm of the force F₁ between the cam and the tappet, R₁₁+h_{α1} denotes a force arm of a friction force F_{f1}
$$L = \frac{{dh}_{α 1}}{d α} .$$

7. The kinetic analysis method for a marine valve camshaft system in consideration of a friction effect according to claim 6, wherein the computing torsional vibration of the valve camshaft system in S2 comprises:
S21, conducting data collection: collecting the stiffness, the damping and the moment of inertia of the camshaft system, and defining the excitation condition of the valve cam load torque;
S22, conducting equation establishment: establishing a shaft system vibration differential equation on the basis of collected data and the excitation condition, wherein the shaft system vibration differential equation is expressed as: [J]{\ddot{ϕ}}+[C]{\dot{ϕ}}+[K]{ϕ}={T}, wherein
[J] denotes a shaft system lumped-inertia matrix, [C] denotes a shaft system damping matrix, [K] denotes a shaft system stiffness matrix, {T}denotes an excitation vector, free vibration is indicated in response to {T}=0, and forced vibration is indicated in response to {T}≠0;
S23, conducting performance evaluation: analyzing friction lubrication performance of the cam pair at a steady rotational speed, analyzing torsional vibration of the camshaft system in consideration of excitation of a connecting gear system and in combination with structural parameters, stiffness-damping parameters and excitation torque of the camshaft system, and obtaining an influence degree of the friction excitation on shaft system torsional vibration; and
S24, conducting equation verification: analyzing, on the basis of rotational speed fluctuation of the cam pair obtained by the torsional vibration of the camshaft system, an influence degree of the rotational speed fluctuation on friction lubrication of the cam pair, and verifying accuracy of the shaft system vibration differential equation.

8. The kinetic analysis method for a marine valve camshaft system in consideration of a friction effect according to claim 7, wherein the conducting comprehensive result analysis and influence evaluation in S3 comprises:
S31, conducting valve cam pair contact analysis: analyzing change of a curvature radius and a surface speed of air intake and exhaust cam pairs on the basis of operation parameters comprising a base radius, a valve cam rotational speed, a spring pretightening force, spring stiffness and a lumped mass of a valve cam and tappet pair mechanism, and evaluating change of contact load between the cam and the tappet during air intake and exhaust;
S32, conducting valve cam pair friction and lubrication analysis: analyzing change of an oil film thickness and a friction force between a valve cam and tappet pair, computing a bonding temperature between lubricating oil and a cam material in consideration of influence of surface micro-roughness, and analyzing temperature rise of an air exhaust cam pair; and
S33, conducting valve camshaft system torsional vibration analysis: analyzing change of additional stress at a camshaft end caused by rotational speed fluctuation and friction excitation in consideration of change of load torque of an air intake and exhaust cam after the friction effect, analyzing influence of rotational speed fluctuation on the oil film thickness of the valve cam pair at base circle and peach tip positions, and evaluating a failure risk of interface bonding wear caused by rotational speed fluctuation on the basis of change of tappet interface temperature rise.

9. The kinetic analysis method for a marine valve camshaft system in consideration of a friction effect according to claim 8, wherein a computation formula of the bonding temperature in S32 is as follows:
$${T}_{S} = 80 + ( 0.85 + 1.4 {X}_{W} ) \cdot {X}_{L} \cdot {( {S}_{F} )}^{2} ,$$
wherein
T_{S} denotes the bonding temperature, X_{W} denotes a material structure coefficient, X_{L} denotes a lubricating oil coefficient, and S_{F} denotes a load level when bonding occurs.
